(19) United States
(12) Patent Application Publication
(10) Pub. No.: US 2011/0030848 A1
(43) Pub. Date: Feb. 10, 2011

(54) METHOD FOR PROCESSING WORKPIECES

(76) Inventors: Karl Weinmann, St. Johann (DE); Michael Goller, Muensingen-Rietheim (DE); Christian Beckereit, St. Johann (DE)

Correspondence Address: MICHAEL J. STRIKER, 103 EAST NECK ROAD, HUNTINGTON, NY, 11743, US

(21) Appl. No.: 12/846,195

(22) Filed: Jul. 29, 2010

(30) Foreign Application Priority Data
Aug. 4, 2009 (DE) 10 2009 036 013.1

(51) Int. Cl. B23Q 17/22

(52) U.S. Cl. 144/402

(57) ABSTRACT

A method for machining workpieces in a machine tool, according to which the workpiece (10) is measured in the region of the machining assembly of the machine tool, and deviations from the specified position and/or form of the workpiece (10) are compensated for by controlling the tools (14) and/or the workpiece (10) accordingly.

In the use of modern machine tools it is common to measure the position of a workpiece in the region where it is clamped. The position of the workpiece is determined relative to the clamping fixture. If the workpiece becomes displaced from an ideal clamped position, the clamping of the workpiece can be corrected, or the production data on the subsequent processing are converted to reflect the actual position of the workpiece to ensure that the workpiece is machined without error.

For workpieces that have been pre-machined, and in the case of which the distance between the clamping and the contact point of the tool is very small, this known measurement of workpieces in the region of the clamping can be carried out to ensure that manufacturing accuracy is sufficient, and to prevent a high rate of rejects.

In particular, in the case of long workpieces composed of a natural material such as wood, or that were subjected to thermal or mechanical stresses in previous machining steps, the deviation of the workpiece position or its shape from the ideal values differs markedly at the contact point of the tool compared to the deviation in the clamping region. In particular, curvatures of the workpiece can result in a large quantity of rejects being produced using the previously known calibration procedure even though the production data of a CNC-controlled machine tool were corrected. Specifically, when diagonal saw cuts are made on curved workpieces, departures from the specified angle of cut and length of the cutting surface occur. If the intention is to subsequently join workpieces that have been machined in this manner to other workpieces, the faulty saw cut can result in the workpiece being unusable.

The object of the present invention, therefore, is to create a way to machine even those workpieces, in a machine tool, that are warped, curved in particular, in a largely error-free manner.

The object is achieved using a method for machining workpieces in a machine tool, the method being characterized by the steps:

Clamp the workpiece in the machine tool;

Measure the workpiece and/or its position in the region of the tool or tools;

Compare the measurement data with setpoint data for the workpiece;

Control the tool or tools and/or a workpiece-moving device depending on the difference between the measurement data and the setpoint data in a manner such that the influence of the deviation of the measurement data from the setpoint data on the machining result is at least partially compensated for by positioning and/or shifting the tool or tools relative to the workpiece.

In contrast to the calibration procedures used with known machine tools, in the method according to the invention, the workpiece is no longer measured at the clamping fixture, but rather in the region of the tool or tools. As a result, any deviations in the position of the workpiece in the machine tool and/or in its shape can be detected at the point at which the tool subsequently engages. Departures from the specified position or form of workpieces can therefore be compensated for in the machining result with a much higher degree of accuracy than is possible using the known methods. The use of the method according to the invention is therefore particularly advantageous for woodworking machines since workpieces made of wood are more likely to warp or the like, due to their relatively inhomogeneous material composition, than is the case e.g. for workpieces composed of metal.

To ensure that the subsequent machining of the workpiece is not hindered by the tool or tools, the measurement device for the workpiece can preferably be moved into the machining region and then removed from the machining region only for the purpose of performing the actual measurement.

Any known measurement procedure can be used as the method for measuring the workpiece position and the shape or dimensions of the workpiece. Preferably, the workpiece can be measured mechanically or optically. To perform the measurement mechanically, sensing heads can be provided, for example, which can be moved toward the workpiece at various points on the surface of the workpiece. Any fixed point of the machine tool in the region of the machining assembly can be used as the reference point for the measurement.

Instead of using one or more sensing heads to perform the mechanical measurement, the workpiece can be laser-scanned. An extremely precise depiction of the workpiece and its position can be obtained using this procedure, thereby likewise ensuring that departures from the specified position and/or form of the workpiece can be compensated for in the machining result with a high level of quality.

According to a preferred embodiment of the method according to the invention, the tool or tools or the workpiece-moving device can be controlled in a manner such that the deviation of the measurement data from the setpoint data of the workpiece in terms of at least one property of the machining result, such as angle of cut, machining depth, machining length, or the like, is compensated for entirely.

Depending on the deviation of the position or form of the workpiece from the ideal state, these deviations cannot be compensated for entirely in the machining result. In these cases, a decision must be made as to which criterium of the machining result absolutely must be met so that the machined workpiece can be used further. By controlling the tools or the motion of the workpiece accordingly, it is thereby attempted to attain this property in entirety based on the ideal state, while the fulfillment of other properties is handled as a second priority.

In particular in the case of diagonal cuts made on long pieces of wood, the length of the cutting surface is often more decisive than the angle of the cut, or vice versa. If both properties apply, a compromise can be striven for, thereby ensuring that both properties are approximately fulfilled in the machining result.

The invention also relates to a machine tool for machining workpieces, in particular workpieces composed of wood, the machine tool including a clamping fixture for the workpiece and at least one machining assembly comprising one or more tools, and a device for measuring the workpiece, the machine tool being characterized in that the workpiece can be measured in the region of the machining assembly using the device for measuring the workpiece. To this end, the device for measuring the workpiece can include one or more sensing heads that can be adjusted to come in contact with the workpiece, or it can include a laser scanner. Cameras can also be used to perform an optical measurement of the workpiece and its position.

In any case, the device for measuring the workpiece is connected to the control of at least the machining assembly, and the measurement signals are evaluated in an evaluation device. In that case, the measurement data are compared with the setpoint data on an ideal workpiece that has been clamped into position correctly. The control data for the tool or tools are modified depending on the deviation, that was observed, between the measurement data and the setpoint data. If the workpiece is moved past stationary tools in the machine tool, the motion data for the workpiece can be changed in the same manner, thereby ensuring that the deviation from the specified position or form of the workpiece can be at least largely compensated for in the machining result.

The method according to the invention is explained in greater detail in the following in a schematic illustration, with reference to the drawing.

The drawing shows:

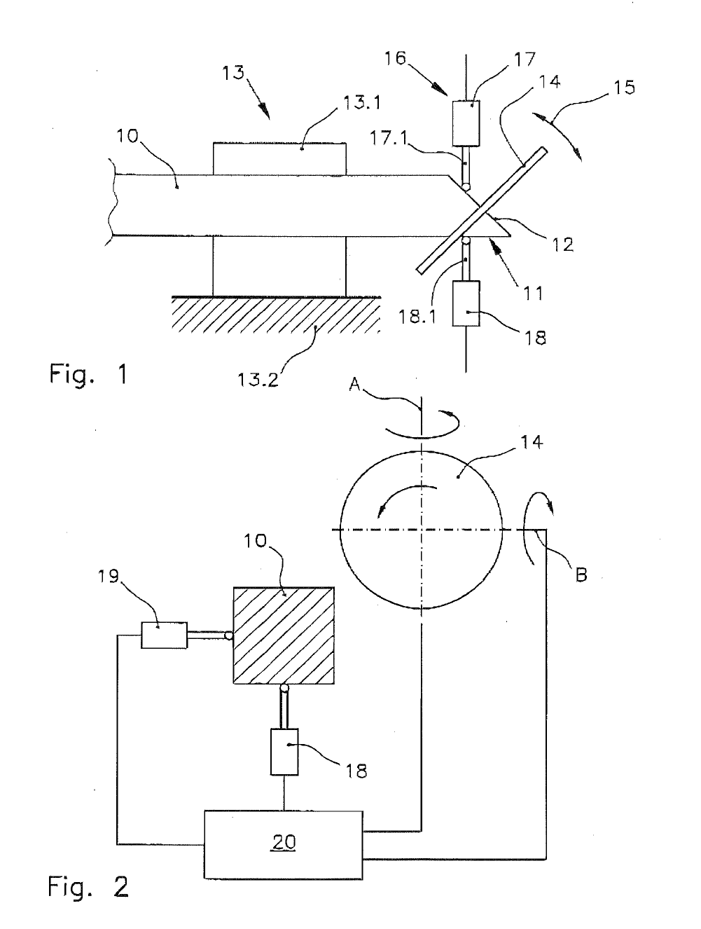

FIG. 1 a schematic illustration of a clamping fixture of a machine tool that includes a workpiece measuring device and a tool;

FIG. 2 a schematic illustration of a measuring of a workpiece and controlling a tool.

FIG. 1 shows a workpiece 10 in the form of a wooden beam which was provided with a diagonal saw cut 12 on its tip 11 in a previous machining step. Workpiece 10 has been clamped in a clamping fixture 13; two clamping jaws, 13.1 and 13.2, of clamping fixture 13 are shown. Clamping jaw 13.2 is stationary, while clamping jaw 13.1 can be opened. A tool 14, which is a saw blade in this case, is also shown; tool 14 will be used to create a second diagonal saw cut in workpiece 10. In the example shown, saw blade 14 can be swiveled in the direction of double arrow 15, thereby enabling the angle of saw cut to be adjusted.

FIG. 1 also shows a device 16 for measuring workpiece 10. Device 16 is disposed in the region of saw blade 14 i.e. in the region of the next machining of workpiece 10. Two sensing heads 17 and 18 of measuring device 16 are shown, each of which has a tip 17.1 and 18.1, respectively, and which can be moved toward the surface of workpiece 10. Preferably, four sensing heads can be specified, for all sides of workpiece 10. In this manner, the position of workpiece 10 and its dimension in the region of circular saw blade 14 can be determined. Any deviations in the measurement data from specified setpoint data can be compensated for, at least in terms of the angle of cut, by swiveling saw blade 14 accordingly in one of the directions of double arrow 15. It is also possible to compensate for errors by changing the starting point of the saw cut.

The compensation of possible workpiece errors or errors in the clamping of the workpiece in the machining result is illustrated in greater detail in FIG. 2. In the schematic illustration, workpiece 10 is shown from the front. As parts of measuring device 16, lower sensing head 18 and a sensing head 19, which is not shown in FIG. 1, are depicted. All sensing heads 17, 18, 19 measure the distance of the surfaces of workpiece 10 relative to a reference point which is not shown, but which can be situated at any fixed point on the machine.

The measurement data are then transmitted to a central evaluation and control device 20 of the machine tool. There, the measurement data are compared with setpoint data on the dimensions and position of workpiece 10, which are stored in a memory in device 20. On the basis of deviations of the measurement data from the ideal state, which may be identified, saw blade 14, which can be swiveled about axes A and B, is then controlled in terms of the pivot angle about these angles and the contact point of saw blade 14 on workpiece 10 in a manner such that the influence of the deviation of workpiece 10 from the ideal state on the desired machining result is minimized to the greatest extent possible.

The compensation of the deviations that were measured can also apply to only one of the various properties of the machining result. As an alternative, saw blade 14 can be controlled in a manner such that a compromise is reached between all desired properties of the machining result of workpiece 10.

What is claimed is:

1. A method for machining workpieces (10) in a machine tool, which is characterized by the steps:
Clamp the workpiece (10) in the machine tool;
Measure the workpiece (10) and/or its position in the region of the tool or tools (14);
Compare the measurement data with setpoint data for the workpiece (10);
Control the tool or tools and/or a workpiece-moving device depending on the difference between the measurement data and the setpoint data in a manner such that the influence of the deviation of the measurement data from the setpoint data on the machining result is at least partially compensated for by positioning and/or shifting the tool or tools (14) relative to the workpiece (10).

2. The method according to claim 1,
characterized in that
the tool or tools (14) or the workpiece-moving device can be controlled in a manner such that the deviation of the measurement data from the setpoint data of the workpiece (10) in terms of at least one property of the machining result, such as angle of cut, machining depth, machining length, or the like, is compensated for entirely.

3. The method according to claim 1,
characterized in that
the tool or tools (14) or the workpiece-moving device is controlled in a manner such that the deviation of the measurement data from the setpoint data of the workpiece (10) in terms of all desired properties of the machining result is compensated for entirely in the form of a compromise.

4. The method according to claim 1,
characterized in that
the workpiece (10) is measured mechanically and/or optically.

5. The method according to claim 1,
characterized in that
the workpiece (10) is measured using sensing heads (17, 18, 19) that can be moved toward the workpiece surface.

6. The method according to claim 1,
characterized in that
the workpiece (10) is measured using laser scanning.

7. A machine tool for machining workpieces, in particular workpieces composed of wood, the machine tool including a clamping fixture (13) for the workpiece (10), and at least one machining assembly comprising one or more tools (14), and a device (16) for measuring the workpiece,
characterized in that
the workpiece (10) can be measured in the region of the machining assembly using the device (16) for measuring the workpiece.

8. The machine tool according to claim 7,
characterized in that
the device (16) for measuring the workpiece (10) can be moved into and out of the region of the machining assembly.

9. The machine tool according to claim 7,
characterized in that
the device (16) for measuring the workpiece (10) can be shut off.
